(19) United States
(12) Patent Application Publication
(10) Pub. No.: US 2010/0175777 A1
(43) Pub. Date: Jul. 15, 2010

(54) CONTAINER, SUCH AS TUBE OR THE LIKE, THE FILLING AND CLOSING PROCESS THEREOF, AND THE DISPENSING PROCESS OF THE REMAINING PROCESS OF THE REMAINING PRODUCT TO BE DISPENSED

(76) Inventor: Sigismund Laskowski, Mannheim (DE)

Correspondence Address: Hoster M. Kasper, 13 Forest Drive, Waren, NJ, 07059, US

(21) Appl. No.: 12/452,455

(22) PCT Filed: Apr. 28, 2008
(86) PCT No.: PCT/EP2008/003412

§ 371 Date: Dec. 30, 2009

(30) Foreign Application Priority Data
Apr. 30, 2007 (DE) 10 2007 020 623.4

(51) Int. Cl. B67D 7/00; B67D 7/60; B65B 3/04

(52) U.S. Cl. 141/2; 222/386

(57) ABSTRACT

The invention relates to a container, such as a tube or the like, for storing and dispensing viscous to paste-like dispensing products, made of plastic, composite, or metal, and having an arbitrary cross-section, wherein the container has a shoulder comprising a dispensing opening, and a cladding that is permanently and tightly connected to said shoulder, wherein the cladding can be tightly closed after filling with the product to be dispensed. After the filling of the tube, or of the container (1), with the product to be dispensed (17), it must be closed air-tight and lastingly by means of a sealing unit (2) later to be taken apart in that a circumferentially extending connection (15, 25) is to be formed, wherein the sealing unit (2) is to be disassembled into a cover (8) having a loop, or a handle (9), and a connecting pin (11), a cover part (4), and a piston part (3) having a connection sleeve (12) dining the dispensing of the remaining product at the latest, wherein the separation of the cover (8) along a separating channel (10) occurs such that the channel is released from the cover part (4), wherein disassembly can occur, for example, by tearing out the cover (8) and can result in a simultaneous release of the connection between the connecting pin (11) and the connection sleeve (12), wherein an opening (26) is formed in the cover part (4), and said opening (26) is shaped such that it ensures direct and sufficiently large access to a piston part (3). By means of an application of force directed approximately axially on the piston part (3) in the direction of a dispensing opening (21), the part can be moved from the retracted position thereof while the cap (14) is open, wherein the remaining product (18) to be dispensed is displaced in a sealing manner while dispensing by means of the lip (30) thereof being pulled off until the remaining product (18) to be dispensed accumulates a sufficient amount of the same in the region between the dispensing opening (21) and the piston part (3), the product being combined again into a product portion to be dispensed (32), and causing the dispensing of part of the product portion to be dispensed (32), for example, by means of targeted pressure applied to the tube cladding (6).

### TECHNICAL FIELD

The invention relates to a container such as a tube or the like for storing and dispensing viscous to pasty products, which is made of plastic, composite material or metal, and which has any desired cross section, whereby said container comprises a shoulder together with a removal opening and a jacket that is firmly and tightly joined thereto, and said container can be tightly closed once it has been filled with dispenser product, according to the generic part of claim 1. The invention also relates to a method for machine-filling and closing the container according to the generic parts of claims 16 and 17, as well as to a method for dispensing especially the remaining dispenser product, according to the generic part of claim 18.

### STATE OF THE ART

PCT/EP2004/009250 discloses a tube with a piston that serves as the basis for a new type of packaging. The advantage of the packaging lies in the fact that it can virtually be the same as a dispenser and can have, for example, the same advertising surface as such a dispenser. Another advantage is that, in contrast to a dispenser, the dispenser product is stored in an air-tight closed state, as a result of which this packaging can now be used for the kind of dispenser product that calls for air-tight pack-aging. The packaging consists of a maximum of four simple parts and is thus simple and cost-effective to assemble. This type of packaging can especially replace dispensers and can be used as packaging for creams, toothpaste, cosmetics, hair dye, household chemicals or the like.

PCT/EP2004/009250 describes, among other things, the closing of a tube with a piston that is configured in one piece and into which a removable separation strip has been integrated. Once the separation strip has been torn out of the piston, said piston is converted into an axially movable piston section and into a circumferential portion that is firmly affixed to the tube jacket.

Actual practice has shown that the configuration described there does not always guarantee a neat separation of the separation strip from the piston, which is a drawback, since the piston has to be configured to be relatively thick so that an undesired deformation does not occur when the separation strip is torn out.

The described tube already has the advantage that it requires a shorter length of the tube jacket in comparison to the circumferential surface of the tube when the tube is produced. However, this aspect has not been optimally implemented, and this has to be considered as a disadvantage. Moreover, it is also to be considered as a disadvantage that the piston as well as the tube jacket need to have a narrow manufacturing tolerance, at least in the join area, in order to ensure an air-tight connection, for example, using an ultrasound device.

### TECHNICAL OBJECTIVE

The invention is based on the objective of refining the prior-art tube or container in such a way that at least some of the above-mentioned disadvantages are overcome. By the same token, it is the objective of the invention to propose methods for filling and closing a tube or container in which the existing filling installations only need to be modified to the least extent possible, and it is also the objective to put forward a method for a simplified removal of the remaining dispenser product.

### DISCLOSURE OF THE INVENTION AS WELL AS ITS ADVANTAGES

This objective is achieved with a container of the above-mentioned type according to the invention in that, after the tube or container has been filled with a dispenser product, said tube or container is closed air-tight and firmly by means of a closing unit that can later be taken apart, in that a completely encircling connection has to be formed, whereby, at the latest when the remaining dispenser product has to be removed, this closing unit can be broken down into a lid with a tab or a handle and connecting pins, a covering part and a piston part along with a connection sleeve, whereby the separation of the lid along a separation channel is to take place in such a way that it is detached from the covering part, whereby this detachment, which can be effectuated, for example, by tearing out the lid, results in a simultaneous separation of the connection between the connecting pin and the connection sleeve, and in that, consequently, on the one hand, a free opening has to be formed in the covering part, and in that, on the other hand, this opening has to be formed in such a way that it ensures a direct and sufficiently large access to a piston part arranged behind said opening, and in that, through the application of force approximately in the axial direction against this piston part in the direction of a removal opening, with the closure cap having been previously opened, said piston part has to be moved out of its sunk position and, in this process, the remaining dispenser product has to be moved in front of the piston part by means of its scraping lip so as to become compacted, until a sufficient amount of the remaining dispenser product has been collected in the area between the removal opening and the displaced piston part, said remaining dispenser product uniting again to form a portion of dispenser product and bringing about the removal of some of the portion of dispenser product, for example, by means of a systematic pressure on the tube jacket, which has to be applied between the removal opening and the piston part.

In another inventive embodiment of the container, a closing unit consists of a piston part and of a covering part, whereby their size, shape and dimensions have to be coordinated with each other in such a way that, on the one hand, at the latest after the removal of a lid, they can easily be separated from each other, but form a stable unit for assembly purposes.

In another inventive embodiment of the container, the supporting surfaces on the covering part and on the piston part have a conical shape, whereby they have to be coordinated with each other in such a way that, on the one hand, they ensure a firm support and, on the other hand, can be separated with very little force.

In another inventive embodiment of the container, the supporting surfaces on the covering part and on the piston part have a parallel shape, whereby they have to be coordinated with each other in such a way that, on the one hand, they ensure a firm fit against each other and, on the other hand, can be separated with very little force.

In another inventive embodiment of the container, the tube jacket or container jacket and the covering part have a linear shape in the area of a firm connection to a covering part.

In another inventive embodiment of the container, the tube jacket or container jacket has an angled area, whereby the covering part has at least one angled area, and these have to be coordinated with each other in such a way that, on the one hand, their tight and firm connection is always ensured, using, for example, an ultrasound device, and, on the other hand, that the widened standing surface thus formed is always stable.

In another inventive embodiment of the container, the piston part always has an insignificantly smaller diameter than the inner diameter of the tube jacket or container jacket, so that, on the one hand, its axial movement always takes place in a gliding manner and, on the other hand, that most of the remaining dispenser product is carried along by its lip.

In another inventive embodiment of the container, the tab or handle is always to be affixed to a detachable lid in such a way that said tab or handle is also removed when the lid is removed.

In another inventive embodiment of the container, the separation channel can have any desired cross section. The separation channel always has a continuous shape, whereby this channel always has to surround the tab along with the lid.

In another inventive embodiment of the container, the upper circumference of an axially movable piston part is shaped into an elastically deformable, scraping lip or edge.

In another inventive embodiment of the container, an air-tight escape cavity for a fixation tip is integrated into the axially movable piston part.

In another inventive embodiment of the container, the piston part always has a jacket with a minimum height, whereby this has to be determined by means of experiments, and whereby it is directly dependent on the tube jacket diameter and on the stiffness of the material of which the piston part is made.

In another inventive embodiment of the container, the total height of the closing unit is always smaller than the cumulative height of a covering part and the height of a piston part.

In another inventive embodiment of the container, the widened standing surface is convex or else it has a different shape.

In a method according to the invention for machine-filling a container such as a tube or the like, with a dispenser product, the container is filled with dispenser product via its jacket opening, whereby the closing procedure is advantageously carried out by means of a closing unit that can be dismantled, as described above.

Moreover, a method for machine-filling a container such as a tube or the like, with a dispenser product is characterized in that the container is filled with dispenser product via a container neck and by means of a filling element, whereby the filling procedure is started at the bottom and is continued upwards in that the filling element advantageously moves along, whereby, after it has been removed from the container neck, the neck is closed air-tight by means of a closure cap.

Moreover, a method for the removal of remaining dispenser product from a container such as a tube or the like is characterized in that, after removal of the dispenser product according to the state of the art, like in a tube, the lid is separated from the covering part along the separation channel by means of a tab and is then removed, after which a closure cap is opened and the piston part that can be directly reached via the opening that has just been created is moved by means of, for example, a finger or a toothbrush in the direction of the removal opening until the remaining dispenser product unites again to form a portion of dispenser product, whereby, when the first dispenser product emerges from the removal opening, the procedure is discontinued or continued until a portion of the desired size has been removed.

Moreover, with a tube or container of the generic type described above, the objective is achieved according to the invention in that, especially the bottom area of a tube jacket or of a container is shaped into such a form that, by simply introducing a closing unit that corresponds thereto, an air-tight connection between a covering part and the tube jacket can always be established, for example, using an ultrasound device, even in the case of larger manufacturing tolerances of the tube jacket. This is achieved according to the invention in that the bottom area of a jacket of a tube or of a container has to be shaped into a section that is angled one or more times and that is widened, and in that this is adapted to the shape and size of the covering part in such a way that, on the one hand, its firm connection is simplified and, on the other hand, a larger standing surface is formed, like with a dispenser.

In the case of a tube or container of the generic type described above, it is important to always select the shape and size of a completely removable lid and thus the shape of the separation channel that secures said lid in such a way that, after it has been removed, such a large access to the piston part is ensured that, at the latest when the remaining dispenser product is removed using a finger or an auxiliary means, for example, a toothbrush, said piston part can be displaced, whereby it always has to be axially displaced in an opened tube or in an opened container in the direction of the removal opening, a process in which its scraping lip or edge scrapes the remaining dispenser product from the inner wall and moves it in front of said piston part into the interior, whereby the displacement procedure of the piston part has to be interrupted at the latest when the remaining dispenser product emerges from the removal opening or when the desired portion has been removed. Now the tube or container can be closed in the normal manner by means of an associated closure cap.

Thus, a tube according to the invention or a container according to the invention only reaches the tightness state in the last phase during the removal of the dispenser product, which, right from the start, characterizes a dispenser known from the state of the art.

In order to once again remove remaining dispenser product, the tube or the container first has to be opened and the piston part according to the invention is affixed in that pressure is applied either onto an elastically deformable tube jacket or onto an elastically deformable container wall. Through the application of pressure onto an area of a tube jacket or container jacket that is located between the piston part and the removal opening, the remaining dispenser product that has collected there can be removed. As an alternative, remaining dispenser product can be removed by pushing the piston part further in the direction of the removal opening, which has to be carried out until the piston part comes to rest against the tube shoulder.

A feature of this invention is that a closing unit according to the invention can interact with practically any desired packaging and transportation means that is used in the realm of the tubes or containers, whereby care should be taken to ensure the requisite minimum height of the piston part and its stiffness that prevent it from tilting inside the tube jacket.

Another feature of the invention is that the outer contours of a tube according to the invention can be the same as the contours of the dispenser, since this shape is considered to be a more high-quality type of packaging than a tube, even though users with impaired motor skills often have problems with pressing on a small dispenser button.

The usually financial advantages, greater environmental-friendliness, improved user-friendliness and the marketing advantages promote especially the tubes configured according to the invention, since their outer shape and design are similar to the various dispensers, an aspect that is also a constituent of this invention.

Especially for expensive cosmetic products, the design and use of a closing unit according to the invention for closing a container and its later activation for the removal of remaining dispenser product constitute a sought-after, environmental friendly alternative, with which the remaining dispenser product can be removed reliably and simply.

Another important feature of the invention is the fact that the cross section of the tube or of the container can have practically any desired shape and size such as, for example, oval, angular, semicircular, etc. In this context, it is important for its size not to be less than about 20 mm, if the intention is for a finger to be used to displace the piston part according to the invention.

This invention was based on fulfilling a wish that has long been expressed by final consumers, especially those who more and more often cut open a tube in order to remove the product remaining in the container, which can amount to up to 20% of the net contents and which cannot be reached in any other manner.

Such an approach also pays heed to the environmental protection legislation, which is becoming ever stricter, since, on the one hand, even unused remaining toothpaste contaminates the environment and, on the other hand, this forces the user to purchase more of the product sooner than necessary. Moreover, unnecessary packaging components are produced and assembled, which likewise translates into superfluous consumption of energy and material.

Generally speaking, the main advantages of the invention can be defined as follows:

a) while retaining the exact outer contours of a dispenser known from the state of the art and thus retaining the same advertising surface, such a dispenser based on a tube and an interacting closing unit can be structured inexpensively, with the advantage that the dispenser product remains closed air-tight and it is removed essentially like with a tube;

b) an inventive shortening of the total length of a closing unit, which, especially due to a sunk arrangement of the piston part in/on the covering part or vice versa, allows according to the invention a further shortening of the needed length of the tube jacket, whereby this depends directly on the inner diameter of a tube, that is to say, the larger its inner diameter, the smaller the savings in terms of the tube jacket length;

c) due to the inventive angling—adapted to the shape of the covering part—of the lower area of a tube jacket or of the lower area of a container as well as their combination according to the invention, the advantageous formation of an air-tight connection area, for example, using an ultrasound device, is always guaranteed, even with larger tolerances than usual;

d) the inventive arrangement and shaping of a closing unit as well as its positioning in a thin-walled tube jacket angled according to the invention allow the formation of a sufficiently stable standing surface, like with a dispenser;

e) the covering part according to the invention has to be configured and affixed to the tube jacket in such a way that, even after a practical removal of the lid, the piston part is always prevented from falling out;

f) if the contour of the working surface of a piston is adapted to the contour of the inner surface of a tube shoulder that interacts with it, then it can be guaranteed that 99.5% of the dispenser product can be removed;

g) the piston part according to the invention and the covering part according to the invention have to be coordinated with each other in such a way that, after the removal of the lid, they guarantee an easy displacement of the piston part, but such that they can be handled as a unit for purposes of introduction into the tube jacket or the like;

h) the subject matter of this invention also encompasses any desired oval and angular cross sections of a closing unit and thus oval or angular cross sections of a tube, even independently of the shape of the tube shoulder. In this embodiment, the closing unit has to be advantageously positioned opposite from the tube shoulder during the assembly.

In another embodiment of the invention, if a striped strand of the dispenser product has to be removed from the tube later on, the piston according to the invention has to be provided with an escape cavity into which the end of the fixation tip that protrudes towards the back and that allows the formation of such strips can escape, especially during the last phase of the removal of the remaining dispenser product, whereby the size of said cavity has to be adapted to the dimensions of the fixation tip protruding into the tube in such a way that the desired removal of remaining dispenser product is ensured.

Thus, this invention offers a less expensive and more environmental friendly packaging alternative, especially for dispensers, but also for tubes, since their emptying reaches the greatest possible value, virtually 100%.

Another important embodiment of the invention provides that the tube shoulder, along with a removal opening, is arranged either in the middle, in the longitudinal axis of the tube, or that the tube neck is arranged off-center.

Another objective of the invention is achieved in that each embodiment put forward here of a tube or of a container according to the invention, irrespective of the shape and size of the bottom area and of the cross section, can be filled with a dispenser product up to a prescribed level via a tube neck or container neck as well as via the opening of the tube jacket or of the container jacket.

It is important here that, in the case of a filling procedure via the neck, the closing unit has to first be positioned in the jacket and has to be joined to it firmly and air-tight. For the filling procedure, the tube or the container has to be delivered without the covering cap. Only after the filling procedure has been completed—which has to be carried out until a final level is reached—and after the filling element has been removed does the container have to be securely and tightly closed by means of, for example, a hinged covering cap or a plug and a rotatably arranged closure cap. It is important for each closure cap or hinged covering cap permanently reduce the cross section of the neck to a desired, prescribed size.

It is likewise important that, after a tube or container according to the invention has been filled via the opening of a tube jacket or of a container jacket, the jacket, especially in its lower area, can be compressed to such an extent that the filling level of the dispenser product rises, but stays below the connection area, which accounts for better air exclusion during the closing procedure.

In order to minimize air inclusion when a container according to the invention is being closed, it is provided according to the invention that, during the introduction of the closing unit into its final position, the previously compressed jacket can relax advantageously and proportionally to the position of the closing unit, so that as a result, more and more volume is available to accommodate the closing unit since a round cross section is created from a flatter cross section. This is an important feature of the invention, which serves to optimize the necessary length, for example, of a tube jacket, during a filling procedure via the opening of a tube jacket.

An important advantage of the invention is also that most filling operations can use their existing filling installations after carrying out a minor modification, to fill the tubes or containers according to the invention.

If the filling is done via the neck, no modification to the installations is needed, except for the usual adaptation to the diameter of the tube or container that has to be filled, and this entails great financial advantages.

An important feature of the invention is that, during a filling procedure via the neck, a tube or container according to the invention is taken, completely assembled but without the closure cap, to a filling installation.

If the container according to the invention is being filled via the opening of the jacket, the containers have to be taken with an affixed and air-tight closed covering cap to the filling installation.

After said tubes and containers have been filled and closed with a closing unit—optionally with the synchronization of the pressure build-up on a tube jacket or container jacket as described above—each position of the closing unit serves to exert pressure on the jacket, that is to say, the deeper the closing unit projects inwards, the less pressure. the closing unit is in its final position, the pressure on the jacket has to be totally relieved.

Reaching a final position of the closing unit means that the connection area of the covering part is advantageously positioned opposite from the connection area of a jacket or the like.

This is now followed by a firm and air-tight connection of the covering part, for example, to a tube jacket, using an ultrasound device or the like. This connection always has to be carried out at this place and in this form, since it must not detrimentally impact on the removable lid, or on its density.

An important feature of the invention is also that a tube or container according to the invention can be stored, standing either on its closure or on its bottom area. The labeling can be applied as a function of this positioning, that is to say, the labeling always has to be legible in the storage position.

This invention provides a remedy here since it is not important which position a standing tube takes shortly before the removal of the dispenser product, since all of the remaining product can advantageously be removed from the interior by means of a piston part.

Another advantage of the tube or of the container according to the invention is that, irrespective of the modality of its storage, i.e. lying or standing, it is always possible to empty the dispenser product down to a level of a maximum of 1% in that said remaining product is first removed like with a tube and subsequently, by removing the lid from a covering part, an adequately large opening of a prescribed shape is formed behind the piston part.

Using a finger or an auxiliary means, for example, a toothbrush, the piston part—after the closure cap has been opened—has to be pushed in the direction of the removal opening until the remaining dispenser product is sufficiently scraped off the inner wall of the tube jacket and appear in the removal opening. By pushing the piston part further in the same direction, a desired portion of dispenser product can be pressed out.

Thus, according to the invention, the appearance and the advantages of a dispenser such as for example, its large advertizing surface for marketing purposes, can be retained and this can be combined with the advantages of a tube such as, for instance, inexpensive manufacturing, easy removal of dispenser product, air-tight storage until the removal of the remaining dispenser product, more thorough emptying, etc.

Another important feature of the invention lies in the fact that, after the piston part has been displaced, for example, up to about the middle of the jacket, the jacket section that remains after this point in time behind said piston part can be cut off, for example, using a pair of scissors. Hence, a further displacement of the piston is possible without additional auxiliary means, for example, by means of an index finger.

Every single feature, also any desired combination thereof, falls under the full protective scope of the invention and is an integral part thereof, irrespective or whether it involves a tube or a container.

### BRIEF DESCRIPTION OF THE DRAWING, IN WHICH THE FOLLOWING IS SHOWN

FIG. 1 a filled, air-tight closed and complete tube according to the invention, without an angled bottom area, in a longitudinal section,

FIG. 2 a tube according to the invention as shown in FIG. 1, from which most of the dispenser product has been removed and only the remaining dispenser product is still adhering to the inside of the tube jacket and from which the detachably arranged lid has been torn out, in a longitudinal section,

FIG. 3 a detachably affixed lid according to the invention, which has been torn out of the tube shown in FIG. 2 and removed, in a longitudinal section,

FIG. 4 a tube according to the invention as shown in FIG. 2, in which first the closure cap was opened and then the piston was displaced in the direction of the removal opening until the remaining dispenser product has collected between said piston and the removal opening, in a longitudinal section,

FIG. 5 an example of a piston part according to the invention, showing, among other things, a minimum height of its jacket (h3) and its height (h2), in a longitudinal section,

FIG. 6 an example of a covering part that has been adapted to the piston part shown in FIG. 5 and a detachably affixed lid, along with a tab, in a longitudinal section,

FIG. 7 a closing unit according to the invention, consisting of a piston part—shown in FIG. 5—and of a covering part—shown in FIG. 6—whereby here its sunk arrangement can be clearly seen, in a longitudinal section,

FIG. 8 a tube according to the invention, in the phase of its filling with a dispenser product, whereby the filling procedure is carried out using a filling element that is inserted and withdrawn via the tube neck, in a longitudinal section,

FIG. 9 a close-up of the bottom area shown in FIG. 8, in which the details are easier to see, in a longitudinal section,

FIG. 10 another variant of an empty tube according to the invention, in which the bottom area of the tube jacket and of the covering part was angled in such a way as to form a widened standing surface, in a longitudinal section,

FIG. 11 a close-up of the bottom area shown in FIG. 10, in which the details are easier to see, in a longitudinal section,

FIG. 12 is comparable to FIG. 10, except with the difference that the angled bottom area is shaped differently, in a longitudinal section,

FIG. 13 a close-up of the bottom area shown in FIG. 12, in which the details are easier to see, in a longitudinal section,

FIG. 14 another example of an empty tube according to the invention, which can be filled via the opening of a tube jacket, in a longitudinal section,

FIG. 15 a top view of FIG. 14 from the direction “W”,

FIG. 16 a side view of a finished tube according to the invention as shown in FIG. 12, which has a widened standing surface,

FIG. 17 a side view of a finished tube according to the invention as shown in FIG. 1, which is configured without a widened standing surface. This tube can be stored in any desired manner (as an upright tube, standing on its closure, or as a container standing on its bottom).

Ways to implement the invention, whereby parts that are the same or correspond to each other are designated with the same reference numerals:

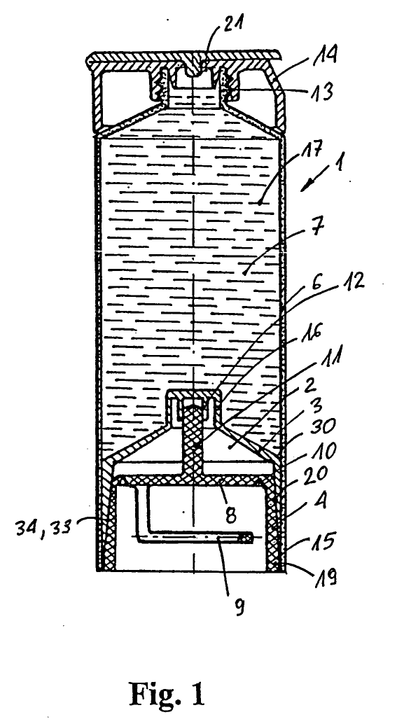

FIG. 1 shows a longitudinal section of a filled, air-tight closed and complete tube 1 according to the invention, without an angled bottom area. Here, it can be clearly seen how the closing unit 2, consisting of a piston part 3 and a covering part 4, is detachably assembled, whereby its sunk arrangement with respect to each other is also clearly shown. The large tube neck 13 indicates that the tube 1 according to the invention was filled by means of a filling element 27 that is inserted and withdrawn via the tube neck 13. Here, the closure cap 14 has the function of reducing the large tube neck diameter to the size of a customary removal opening. The piston section 16, which improves the removal of remaining product and which is adapted to the dimensions of the tube neck 13, is also clearly visible here.

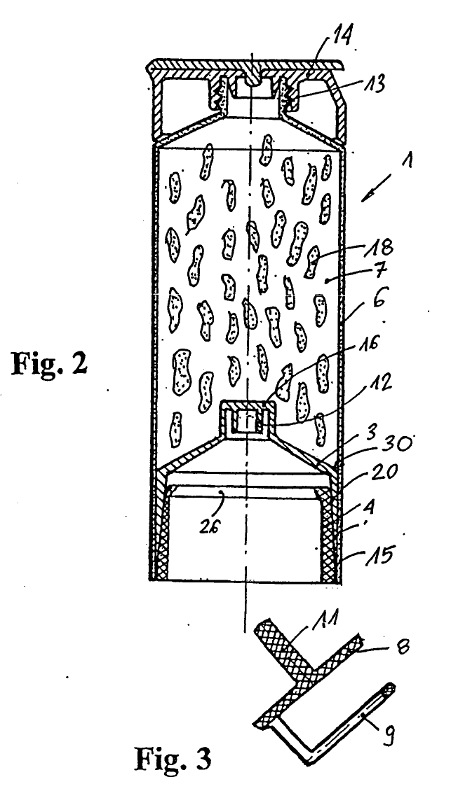

FIG. 2 shows a longitudinal section of a tube according to the invention as shown in FIG. 1, in which only the remaining dispenser product 18 is still adhering to the inside 7 of the tube jacket and from which the detachably arranged lid 8 has been removed. Moreover, it can be clearly seen that, after the removal of the lid 8, a sufficiently large opening 26 has been formed through which direct access to the piston part 3 is possible. The other covering part 4 remains in its previous position, connected to the tube jacket 6 by means of a connection 15. The unchanged position of the piston part 83 with respect to the covering part 14 is clearly visible here.

FIG. 3 clearly shows a longitudinal section of a detachably affixed lid 8 which has been removed from the tube 1 shown in FIG. 2. The tab 9 by means of which the cover 8 was removed is also visible. Moreover, the connecting pin 11 can be seen that previously was part of a covering part 4 and that, together with a sleeve 12 on a piston part 3 guarantees the necessary secure, but detachable, connection between them in order to allow a closing unit 82 to be installed as a unit, for instance, by means of a machine.

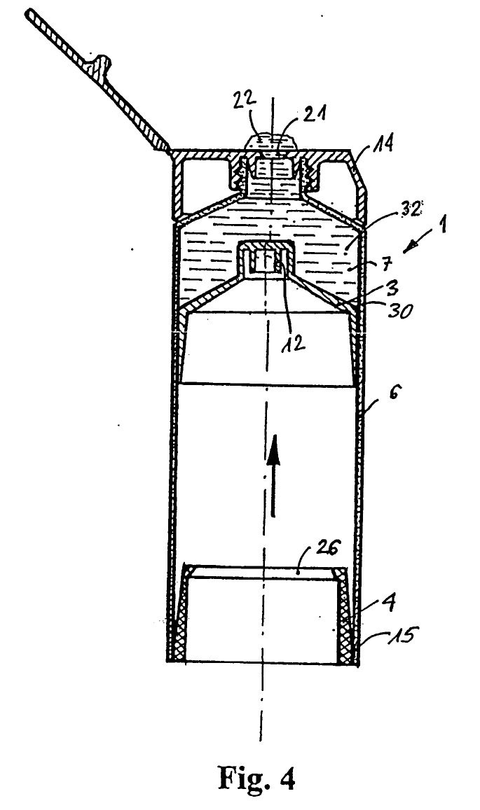

FIG. 4 shows a lengthwise section of a tube 1 according to the invention as shown in FIG. 2, in which first the closure cap 14 was opened and then the piston 3 was displaced in the direction of the removal opening 21 until the remaining dispenser product 18 had collected between said piston and the removal opening 21 and had even partially emerged from it.

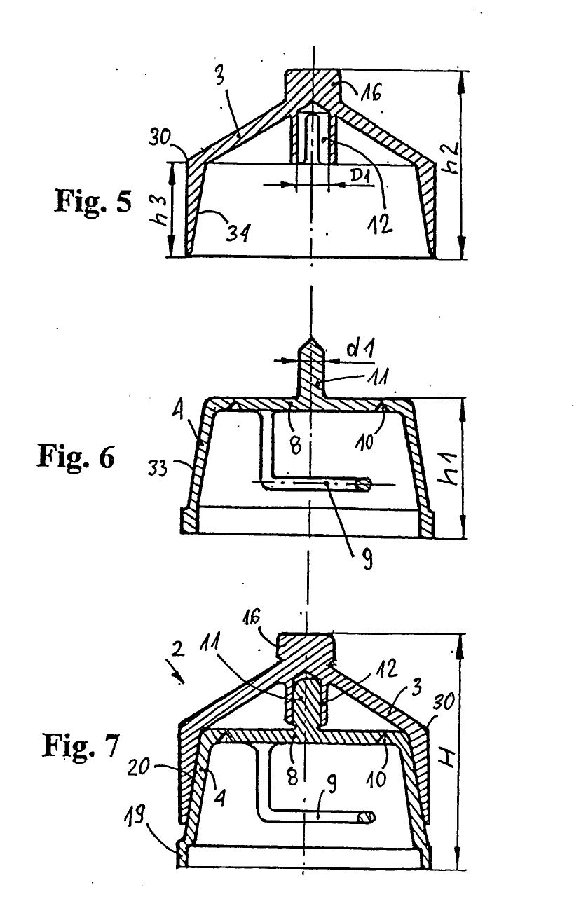

FIG. 5 shows an example of a piston part 3 according to the invention, among other things, with a minimum height of its jacket h3 and its cross section, which are always to be determined in such a way that the piston part 3 is always prevented from tilting in a tube jacket 6. Likewise shown here are the height h2 of the piston part 3, the connection sleeve 12, the diameter D1 of said sleeve, which has been adapted to the dimension d1 of a connecting pin 11 that corresponds thereto, and the scraping lip 30 in a longitudinal section.

FIG. 6 shows in a longitudinal section the example of a covering part 4 that has been adapted to the piston part 3 shown in FIG. 5. Furthermore, the tab 9 and the encircling separation channel 10 are clearly visible. The separation channel 10 has to be configured in such a way that, on the one hand, it guarantees a complete tightness of the covering part 4 during the period of storage and, on the other hand, it always guarantees a neat separation of the lid 8 along with the tab 9 and the connecting pin 11 from the covering part, when a reasonable amount of force is exerted to pull on the tab 9.

FIG. 7 shows a closing unit 2 according to the invention, consisting of a piston part 3 and a covering part 4, in a longitudinal section. The sunk arrangement of the piston part 3 with respect to the covering part 4 can be seen especially clearly here. As a result, the maximum height H of a closing unit 2 is always smaller than the cumulative height h1 of a covering part 4 and the height h2 of a piston part 3. As a result, the overall length of the tube jacket 6 can be even further reduced, which is an important feature of the invention.

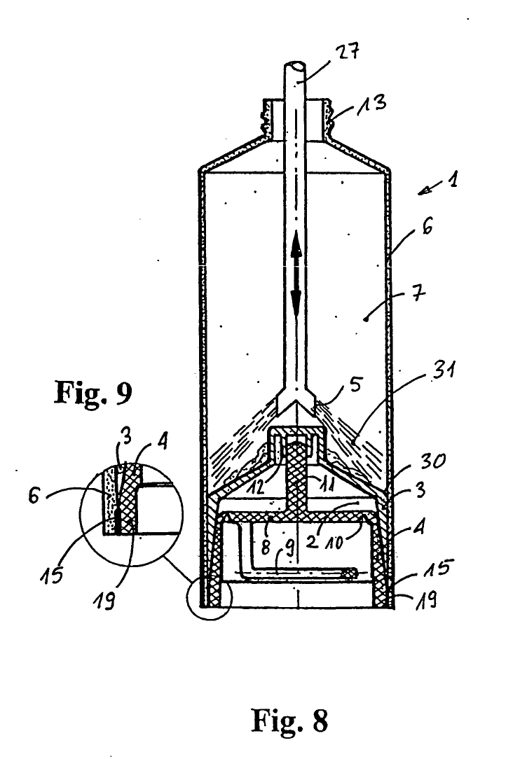

FIG. 8 shows a tube 1 according to the invention in a longitudinal section in the phase of its filling with a dispenser product 31, whereby the filling procedure is carried out by means of a filling element 27 that was inserted via the tube neck 13. Here, it can be easily seen that the closing unit 2 is in perfectly intact condition and that it is firmly joined to the tube jacket 6 by means of a completely encircling tight connection 15. The filling element 27 normally moves upwards during the filling procedure, until this procedure has been completed. Then it has to be removed from the tube neck 13.

FIG. 9 shows a longitudinal section of a close-up of the bottom area of a tube 1 shown in FIG. 8, in which the details are easier to see. Here, it can be clearly seen how the connection area of a covering part 19 was connected air-tight to a tube jacket 6 by means of a firm connection 15.

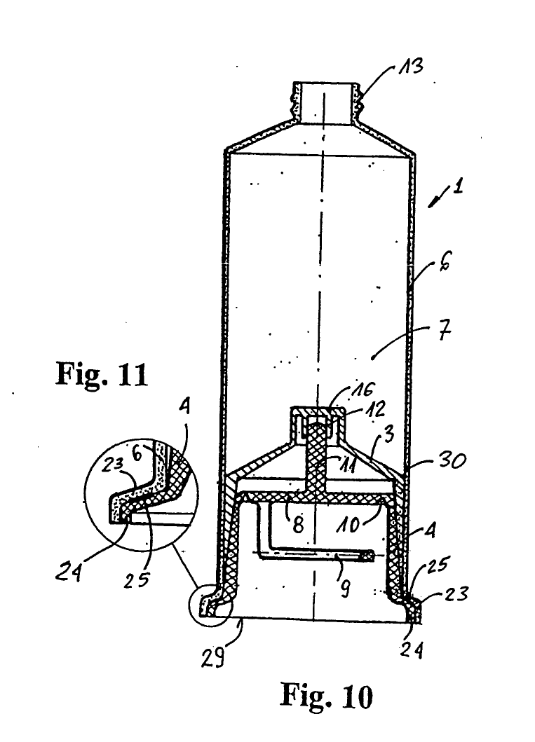

FIG. 10 shows another variant of an empty tube 1 according to the invention, in a longitudinal section, in which the bottom area of the tube jacket 6 and of the covering part 4 was angled in such a way as to form a widened standing surface 2. The form of the angled tube jacket 23 and of the angled covering part 24 proposed here allows the formation of an air-tight connection 25, even in the case of larger manufacturing tolerances than usual, which is an important feature of the invention. Moreover, a tube 1 configured in this manner can completely replace a dispenser seeing that its shape can be totally adapted to such a dispenser, since all dispensers have a widened standing surface 29 in their lower area.

FIG. 11 shows a close-up of the bottom area of a tube 1 shown in FIG. 10, in a longitudinal section. Here, it can be clearly seen that, even when the diameter of the angled covering part 24 is considerably smaller than the inner diameter of the angled tube jacket 23, a firm and air-tight connection 25 is possible between them, which is also an important feature of the invention.

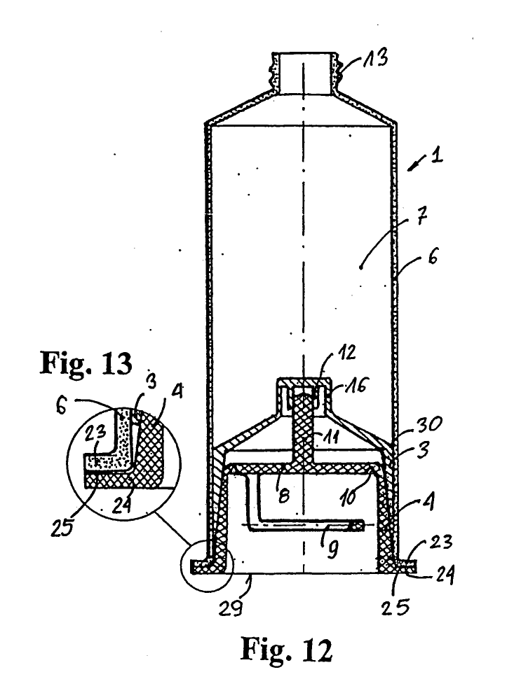

FIG. 12 is comparable to FIG. 10, except with the difference that the angled bottom area of a tube jacket 23 and of the covering part 24 adapted thereto is differently shaped from that in FIG. 10. Here, too, a greater tolerance between an angled area of a tube jacket 23 and an angled area of a covering part 24 does not prevent the formation of an air-tight and firm connection 25. This connection can be created in any desired manner, which is an important feature of the invention. The figure is shown in a longitudinal section.

FIG. 13 shows a close-up of the bottom area of a tube 1 according to the invention as shown in FIG. 12, where the angled shape of a tube jacket 23, of a covering part 24 and of the connection 25 between them is clearly visible. This is shown in a longitudinal section.

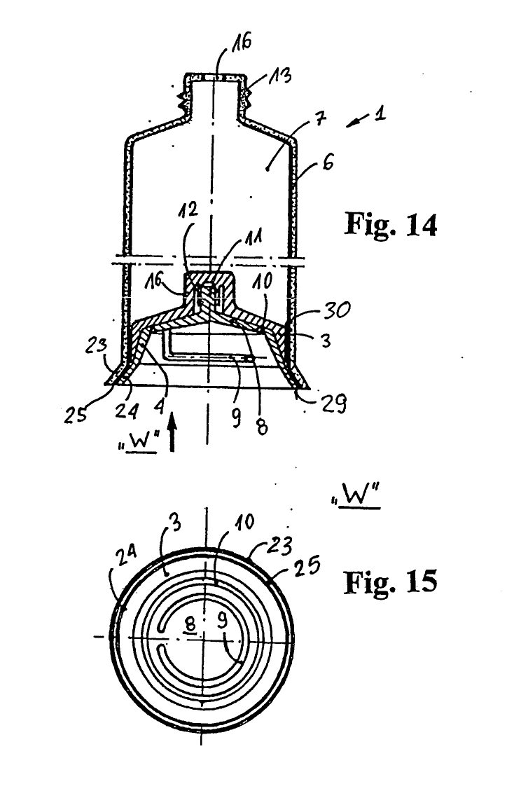

FIG. 14 shows another example of an empty tube 1 according to the invention, which can be filled via the opening of a tube jacket, since its removal opening 16 has been kept small. Here, another variant of a tube 1 according to the invention is shown in a longitudinal section, having a tube jacket 23 that is angled in this manner, and a covering part 24 that is adapted thereto and angled in such a way that they are centered almost automatically with respect to each other. Here, too, it is not absolutely necessary to observe the narrow tolerances known from the construction of dispensers in order to ensure its advantageous, air-tight and firm connection 25. This embodiment, too, can be completely adapted to the shape and size of a given dispenser.

FIG. 15 shows a top view of FIG. 14 in the direction “W”. In this example, a round configuration of the tube 1 as well as of the covering part 4 and of the piston part 3 is shown. Moreover, the shape of the separation channel 10, the arrangement of the tab 9 and of the detachable lid 8 are clearly visible. However, according to the invention, any other configuration of the tube 1 and of the closing unit 2, for example, with an oval or angular cross section, is likewise protected.

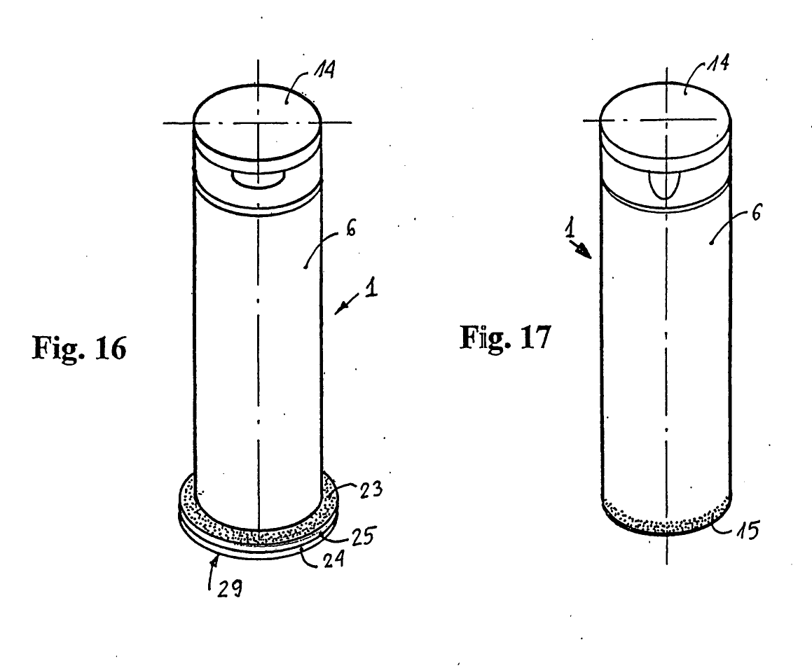

FIG. 16 shows a side view of a finished tube 1 according to the invention with a hinged closure 14 as shown in FIG. 12, which has a widened standing surface 29. This embodiment can be completely adapted to the shape of a dispenser since it has a widened, enlarged standing surface 29.

FIG. 17 shows a side view of a finished tube 1 according to the invention as shown in FIG. 1, which can be stored in any desired manner, i.e. as an upright tube, standing on its closure, or as a container standing on its bottom.

### INDUSTRIAL APPLICABILITY

The subject matter of the invention is industrially applicable, especially in the packaging industry, for cost-effective and environmental friendly packaging for all articles that up until now are offered in tubes, metering dispensers and containers, and whose emptying of the remaining product is not satisfactory since, for example, up to 20% of the net contents of the tube cannot be removed by means of squeezing as is done conventionally. The stability of the subject matters of the invention thus configured is at least as good as that of comparable products known from the state of the art.

### LIST OF REFERENCE NUMERALS

1 tube, container or the like according to the invention

2 closing unit

3 piston part

4 covering part

5 outlet opening in the filling element for dispenser product

6 tube jacket or container jacket

7 interior of tube jacket or interior of container jacket

8 detachably affixed lid

9 tab or handle

10 separation channel

11 connecting pin on the covering part (on the detachably affixed lid)

12 connection sleeve

13 tube neck or container neck

14 closure cap

15 air-tight and firm connection between the tube jacket and the covering part

16 small removal opening in a tube neck

17 dispenser product

18 remaining dispenser product

19 connection area of a covering part

20 adjustment pin on a covering part (on the detachably affixed lid)

21 removal opening

22 emerging dispenser product

23 angled tube jacket area or container jacket area

24 angled covering part area

25 air-tight and firm connection between 23 and 24

26 opening formed by separating the lid (8)

27 filling element

28 dispenser product emerging from a filling element

29 widened standing surface

30 scraping lips of a piston part

31 dispenser product flowing in

32 remaining dispenser product as a portion of dispenser product

33 supporting surface on the covering part (4)

34 supporting surface on the piston part (3)

H total height of a closing unit

h1 height of a covering part

h2 height of a piston part

h3 minimum height of a piston part jacket

d1 diameter of a connecting pin

D1 diameter of an opening in the sleeve

1. A container such as a tube or the like for storing and dispensing viscous to pasty products, which is made of plastic, composite material or metal, and which has any desired cross section, whereby said container comprises a shoulder together with a removal opening and a jacket that is firmly and tightly joined thereto, and said container can be tightly closed once it has been filled with dispenser product, characterized in that,
after the tube or container (1) has been filled with a dispenser product (17), said tube or container is closed air-tight and firmly by means of a closing unit (2) that can later be taken apart, in that a completely encircling connection (15 or 25) has to be formed, whereby, at the latest when the remaining dispenser product has to be removed, this closing unit (2) has to be broken down into a lid (8) with a tab or a handle (9) and connecting pins (11), a covering part (4) and a piston part (3) along with a connection sleeve (12), whereby the separation of the lid (8) along a separation channel (10) is to take place in such a way that it is detached from the covering part (4), whereby this detachment, which can be effectuated, for example, by tearing out the lid (8), results in a simultaneous separation of the connection between the connecting pin (11) and the connection sleeve (12), and in that, consequently, on the one hand, a free opening (26) has to be formed in the covering part (4), and in that, on the other hand, this opening (26) has to be formed in such a way that it ensures a direct and sufficiently large access to a piston part (3) arranged behind said opening, and in that, through the application of force approximately in the axial direction against this piston part (3) in the direction of a removal opening (21), with the closure cap (14) having been previously opened, said piston part has to be moved out of its sunk position and, in this process, the remaining dispenser product (18) has to be moved in front of the piston part by means of its scraping lip (30) so as to become compacted, until a sufficient amount of the remaining dispenser product (18) has been collected in the area between the removal opening (21) and the displaced piston part (3), said remaining dispenser product uniting again to form a portion (32) of the dispenser product and bringing about the removal of some of the portion (32) of the dispenser product, for example, by means of a systematic pressure on the tube jacket (6), which has to be applied between the removal opening (21) and the piston part (3).

2. The container according to claim 1, characterized in that a closing unit (2) consists of a piston part (3) and of a covering part (4), whose size, shape and dimensions are coordinated with each other in such a way that, on the one hand, at the latest after the removal of a lid (8), they can easily be separated from each other, but form a stable unit for assembly purposes.

3. The container according to claim 1, characterized in that the supporting surfaces (33) on the covering part and on the piston part (34) have a conical shape, whereby they have to be coordinated with each other in such a way that, on the one hand, they ensure a firm support and, on the other hand, can be separated with very little force.

4. The container according to claim 1, characterized in that the supporting surfaces on the covering part (33) and on the piston part (34) have a parallel shape, whereby they have to be coordinated with each other in such a way that, on the one hand, they ensure a firm fit against each other and, on the other hand, can be separated with very little force.

5. The container according to claim 1, characterized in that the tube jacket (6) and the covering part (4) have a linear shape in the area of a firm connection (15) to a covering part (4).

6. The container according to claim 1, characterized in that the tube jacket (6) has an angled area (23), and the covering part (4) has an angled area (24), whereby these angled areas have to be coordinated with each other in such a way that, on the one hand, their tight and firm connection (25) always has to be ensured, using, for example, an ultrasound device, and, on the other hand, that the widened standing surface (29) thus formed always has to be stable.

7. The container according to claim 1, characterized in that the piston part (3) always has to have an insignificantly smaller diameter than the inner diameter of the tube jacket, so that, on the one hand, its axial movement always takes place in a gliding manner and, on the other hand, that most of the remaining dispenser product (18) is carried along by its lip (30).

8. The container according claim 1, the preceding claims, characterized in that the tab or handle (9) is always to be affixed to a detachable lid (6) in such a way that said tab or handle (9) is also removed when the lid is removed.

9. The container according to claim 1, characterized in that the separation channel (10) can have any desired cross section.

10. The container according to claim 1, in that the separation channel (10) always has a continuous shape, whereby this channel always has to surround the tab (9) along with the lid (8).

11. The container according to claim 1, characterized in that the upper circumference of an axially movable piston part (3) is shaped into an elastically deformable, scraping lip or edge (30).

12. The container according to claim 1, characterized in that an air-tight escape cavity for a fixation tip is integrated into the axially movable piston part (3).

13. The container according to claim 1, characterized in that the piston part (3) always has to have a jacket with a minimum height (h3), whereby this has to be determined by means of experiments, and in that it is directly dependent on the tube jacket diameter and on the stiffness of the material of which the piston part (3) is made.

14. The container according to claim 1, characterized in that the total height of the closing unit (2) is always smaller than the cumulative height (h1) of a covering part (4) and the height (h2) of a piston part (3).

15. The container according to claim 1, characterized in that the widened standing surface (29) is convex or else it has a different shape.

16. A method for machine-filling a container such as a tube or the like, with a dispenser product (31), according to claim 1, characterized in that the container (1) is filled with dispenser product (31) via its jacket opening, whereby the closing procedure is advantageously carried out by means of a closing unit (2) that can be dismantled, as described above.

17. A method for machine-filling a container such as a tube or the like, with a dispenser product (31), according to claim 1, characterized in that the container (1) is filled with dispenser product (31) via a container neck (13) and by means of a filling element (27), whereby the filling procedure is started at the bottom and is continued upwards in that the filling element (27) advantageously moves along, whereby, after it has been removed from the container neck (13), the neck is closed air-tight by means of a closure cap (14).

18. A method for the removal of remaining dispenser product from a container such as a tube or the like is characterized in that, after removal of the dispenser product according to the state of the art, like in a tube, the lid (8) is separated from the covering part (4) along the separation channel (10) by means of a tab (9) and is then removed, after which a closure cap (14) is opened and the piston part (3) that can be directly reached via the opening (26) that has just been created is moved by means of, for example, a finger or a toothbrush in the direction of the removal opening (21) until the remaining dispenser product (18) unites again to form a portion (32) of the dispenser product, whereby, when the first dispenser product (22) emerges from the removal opening (21), the procedure is discontinued or continued until a portion having the desired size has been removed.
